(19) United States
(12) Patent Application Publication
(10) Pub. No.: US 2024/0036855 A1
(43) Pub. Date: Feb. 1, 2024

(54) METHOD AND SYSTEM FOR UPDATING IoT FIRMWARE USING CONSENSUS ALGORITHM OF BLOCKCHAIN

(71) Applicants: The Research & Business Development Center of KNPU, Asan-si (KR); Korea Internet & Security Agency, Naju-si (KR)

(72) Inventors: Cheol Hee YOON, Asan-si (KR); Jang Mook KANG, Seoul (KR); Jee Rhyang KIM, Suwon-si (KR); Dae Il JANG, Naju-si (KR); Yong Hee SHIN, Naju-si (KR)

(21) Appl. No.: 18/328,012

(22) Filed: Jun. 2, 2023

(30) Foreign Application Priority Data
Aug. 1, 2022 (KR) 10-2022-0095429

(51) Int. Cl. G06F 8/65; H04L 9/00; H04L 67/1097

(52) U.S. Cl. CPC G06F 8/65; H04L 9/50; H04L 67/1097

(57) ABSTRACT

Exemplary embodiments provide a method and a system for updating firmware based on a blockchain which store information about heterogeneous IoT firmware in a distributed block node to build an authentication blockchain and automatically update the heterogeneous IoT firmware using a consensus algorithm based on a block node which forms the authentication block chain.

### CROSS-REFERENCE TO RELATED APPLICATIONS

This application claims priority to and the benefit of Korean Patent Application No. 10-2022-0095429 filed in the Korean Intellectual Property Office on Aug. 1, 2022, the entire contents of which are incorporated herein by reference.

### BACKGROUND

### Field

A technical field of the present disclosure relates to a method and a system for automatically updating an IoT firmware using a consensus algorithm of a blockchain.

This work was supported by Institute of Information and communications Technology Planning and Evaluation (IITP) grant funded by the Korea government (MSIT) (No. 2020-0-00901, Information tracking technology related with cyber crime activity including illegal virtual asset transactions)

### Description of the Related Art

The contents described in this section merely provide background information on the present exemplary embodiment but do not constitute the related art.

A blockchain is a recent technique applied to each social service area including public and civil areas. Blockchain has developed in terms of management of ledgers as a final step of information transfer and transaction processing for payment and settlement transactions, and currently, the diversity of its use is expanding with the prospect of being applied to data processing (a sealing technology to ensure integrity) of technologies to be realized in the future, such as autonomous vehicles.

The payment method is largely classified into a centralized processing method and a distributed processing method. It is developing from the traditional data storage and processing method to the direction of ensuring integrity in a super-distributed environment where reliability is not damaged even when an unspecified number of people participates. FIG. 1 is a view illustrating data processing in a centralized infrastructure and a blockchain network in a super-distributed environment.

The blockchain is utilized as a technology to seal driving information, driver information, other sensitive personal information combining issue, and accident data of an unspecified number of people with integrity, such as autonomous vehicles. There are work, trust, and stake proof methods as a technique for processing by an unspecified number of people in a super-distributed environment.

### RELATED ART DOCUMENT

### [Patent Document]

(Patent Document 1) Korean Registered Patent Publication No. 10-2113265 (May 14, 2020)

(Patent Document 2) Korean Registered Patent Publication No. 10-2142259 (Aug. 3, 2020)

(Patent Document 3) Korean Registered Patent Publication No. 10-2412444 (Jun. 20, 2022)

### SUMMARY

A main object of exemplary embodiments of the present disclosure is to store information about heterogeneous IoT firmware in a distributed block node to build an authentication blockchain and automatically update the heterogeneous IoT firmware using a consensus algorithm based on a block node which forms the authentication block chain.

Other and further objects of the present disclosure which are not specifically described can be further considered within the scope easily deduced from the following detailed description and the effect.

According to an aspect of the present embodiment, a blockchain based firmware update method by a blockchain based firmware update system includes building an authenticated blockchain by storing information about heterogeneous IoT firmware in a distributed block node; and updating the heterogeneous IoT firmware based on a block node which forms the authenticated blockchain.

The updating includes selecting an appropriate node consensus algorithm based on a traffic amount of sensing data collected from the heterogeneous IoT firmware.

The updating includes identifying a version of the firmware update by means of the smart contract recorded in the authenticated blockchain.

The updating includes: updating by executing the smart contract of the authenticated blockchain after changing the selected node consensus algorithm to another node consensus algorithm according to the change in the traffic amount of the sensing data.

In the updating, the cost for the update is processed by a virtual asset exchange device of the firmware update system.

According to another aspect of the present embodiment, in a blockchain based firmware update system including a cyber security device and a virtual asset exchange device, the cyber security device and the virtual asset exchange device build an authenticated blockchain by storing information about a heterogeneous IoT firmware in a distributed block node, and the cyber security device updates the heterogeneous IoT firmware based on a block node which forms the authenticated blockchain.

The cyber security device selects an appropriate node consensus algorithm based on a traffic amount of sensing data collected from the heterogeneous IoT firmware.

The cyber security device identifies a version of the firmware update by means of a smart contract recorded in the authenticated blockchain.

The cyber security device updates by executing the smart contract of the authenticated blockchain after changing the selected node consensus algorithm to another node consensus algorithm according to the change in the traffic amount of the sensing data.

The virtual asset exchange device processes the cost for the update.

A cyber security device of the firmware update system is connected to a first block chain group and a virtual asset exchange device of the firmware update system is connected to a second blockchain group.

The 1-1-th gate block node and the 1-2-th gate block node belonging to the first block chain group may form a blockchain gate connection path in the 2-1-th gate block node and the 2-2-th gate block node belonging to the second block chain group.

The blockchain gate connection path may be connected in one of connection mode of a single line direct connection mode, a multiple line direct connection mode, a single line diagonal connection mode, and a multiple line diagonal connection mode.

As described above, according to the exemplary embodiments of the present disclosure, information about heterogeneous IoT firmware is stored in a distributed block node to build an authentication blockchain and the heterogeneous IoT firmware is automatically updated using a consensus algorithm based on a block node which forms the authentication block chain.

Even if the effects are not explicitly mentioned here, the effects described in the following specification which are expected by the technical features of the present disclosure and their potential effects are handled as described in the specification of the present disclosure.

### BRIEF DESCRIPTION OF DRAWINGS

FIG. 1 is a view illustrating data processing in a centralized infrastructure and a blockchain network in a super-distributed environment;

FIG. 2 is a view illustrating various consensus algorithms of a block chain;

FIG. 3 is a view illustrating a firmware update system according to an exemplary embodiment of the present disclosure;

FIGS. 4 and 5 are flowcharts illustrating a firmware updating method according to another exemplary embodiment of the present disclosure;

FIG. 6 illustrates comparison between consensus algorithms of a blockchain;

FIG. 7 is a view illustrating transaction propagation of a blockchain network to which a firmware update method according to another exemplary embodiment of the present disclosure is applied;

FIG. 8 is a view illustrating a blockchain group and a block node to which a firmware update system according to another exemplary embodiment of the present disclosure is applied; and

FIG. 9 is a block diagram illustrating a computing device which carries out exemplary embodiments of the present disclosure.

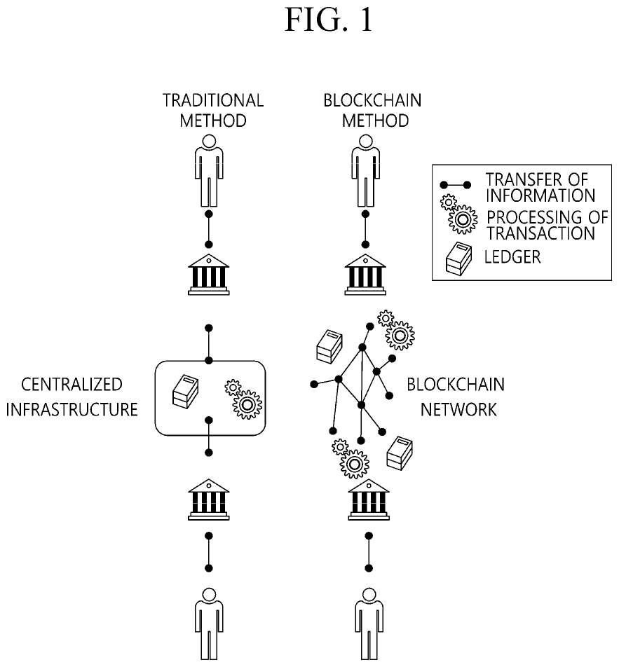

### DETAILED DESCRIPTION OF THE EMBODIMENT

Hereinafter, in the description of the present disclosure, a detailed description of the related known functions will be omitted if it is determined that the gist of the present disclosure may be unnecessarily blurred as it is obvious to those skilled in the art and some exemplary embodiments of the present disclosure will be described in detail with reference to exemplary drawings.

The consensus algorithm is a core principle which ensures the integrity of the blockchain. Proof of work, proof of stake, and proof of trust are analyzed to be applicable to an IoT firmware, such as autonomous vehicles.

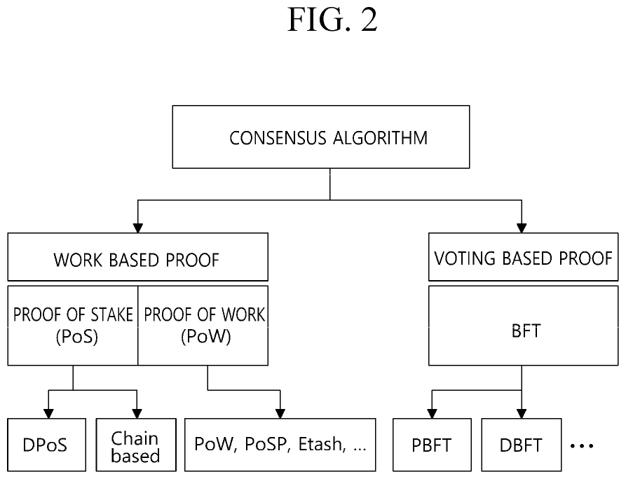

There are various types of consensus algorithms which are characterized by probability. Proof of stake, proof of work, and proof of trust are representatives. FIG. 2 is a view illustrating various consensus algorithms of a block chain. Each method may be replaced with social science principles which are characterized by the indirect, direct, and trust transfer of the democratic voting methods. These principles are expressed as abstraction of technical implementations.

The integrity of accident data in autonomous vehicles may be ensured by combinations of various algorithms and methods to prove the algorithms.

The IoT firmware may implement a blockchain by considering each of various sensing data attached to an autonomous vehicle as an individual node, for example. At this time, as a consensus algorithm that guarantees the reliability and integrity of each block, the existing proof of work, proof of trust, proof of stake, and other algorithms can be converged and utilized.

During the demonstration process, specific application guidelines may be established according to the characteristics of the data (for example, sealing speed, traffic volume, stability level, etc.).

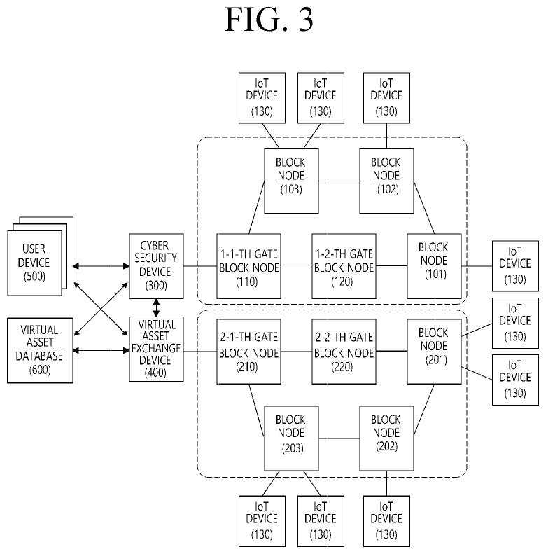

FIG. 3 is a view illustrating a firmware update system according to an exemplary embodiment of the present disclosure.

A blockchain based firmware update system includes a cyber security device 300, a virtual asset exchange device 400, a plurality of user devices 500, a virtual asset database 600, and an IoT device 130.

The cyber security device 300 and the virtual asset exchange device 400 stores information about firmware of heterogeneous IoT devices 130 in distributed block nodes 101, 102, 103, 201, 202, and 203 to build an authenticated blockchain. One or more IoT devices 130 are connected to the block bode.

The security device 300 stores metadata of the firmware in distributed block nodes 101, 102, 103, 201, 202, and 203 and stores a firmware file in a distributed file storage system such as Interplanetary file system (IPFS) or Bittorrent. The metadata of the firmware may include a vender name, an IoT device type, a version of the firmware, a URL (uniform resource indicator) for downloading the firmware, a checksum, and a hash value of the firmware. The cyber security device 300 may generate a transaction using the metadata of the firmware. This transaction verifies whether a version of the firmware is higher than a version of an already registered firmware and updates the firmware in the block node to ensure the data integrity.

The cyber security device 300 may update the firmware of the heterogeneous IoT devices 130 based on the block nodes 101, 102, 103, 201, 202, and 203 which form the authenticated blockchain.

The IoT device 130 periodically generates a transaction to confirm whether the currently possessed firmware is the latest firmware from the metadata of the block node. If the currently possessed firmware is not the latest firmware, the IoT device 130 downloads a firmware file from the distributed file storage system, such as interplanetary file system (IPFS) or Bittorrent, using the URL included in the metadata of the block node.

The cyber security device 300 selects an appropriate node consensus algorithm based on a traffic amount of sensing data collected from the heterogeneous IoT devices 130. The cyber security device 300 confirms the firmware version by means of a smart contract recorded in the authenticated blockchain. The cyber security device 300 changes a node consensus algorithm selected according to the change in a traffic amount of the sensing data into another node consensus algorithm, and then executes the smart contract of the authenticated blockchain to update the firmware.

The virtual asset exchange device 400 processes a cost for updating the firmware.

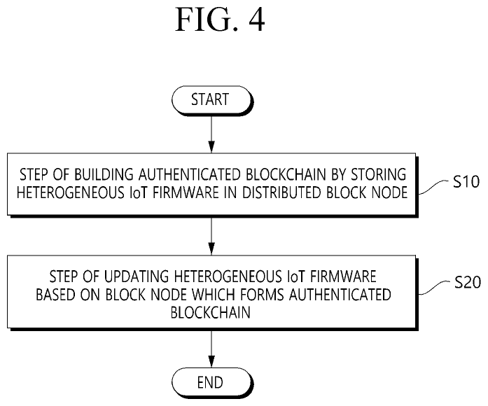

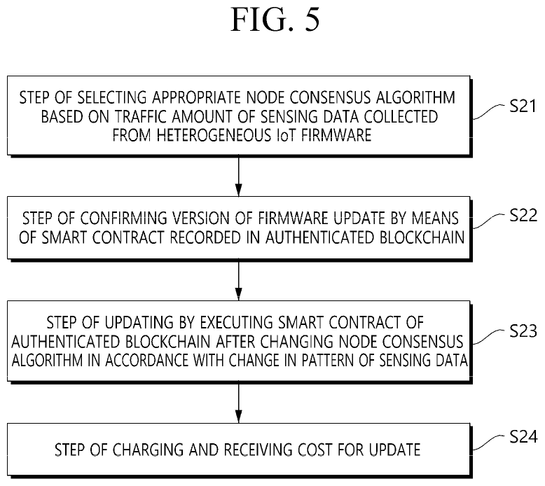

FIGS. 4 and 5 are flowcharts illustrating a firmware updating method according to another exemplary embodiment of the present disclosure.

The blockchain based firmware update method is performed by a blockchain based firmware update system.

Referring to FIG. 4, in step S10, a step of building an authenticated blockchain by storing information about a heterogeneous IoT firmware in a distributed block node is performed.

In the step of building an authenticated blockchain, the metadata of the firmware is stored in the distributed block node and the firmware file is stored in a distributed file storage system. The metadata of the firmware may include a vender name, an IoT device type, a version of the firmware, a URL (uniform resource indicator) for downloading the firmware, a checksum, and a hash value of the firmware.

In step S20, a step of updating the heterogeneous IoT firmware based on the block node which forms the authenticated blockchain is performed.

Referring to FIG. 5, the updating step includes a step S21 of selecting an appropriate node consensus algorithm based on a traffic amount of the sensing data collected from the heterogeneous IoT firmware.

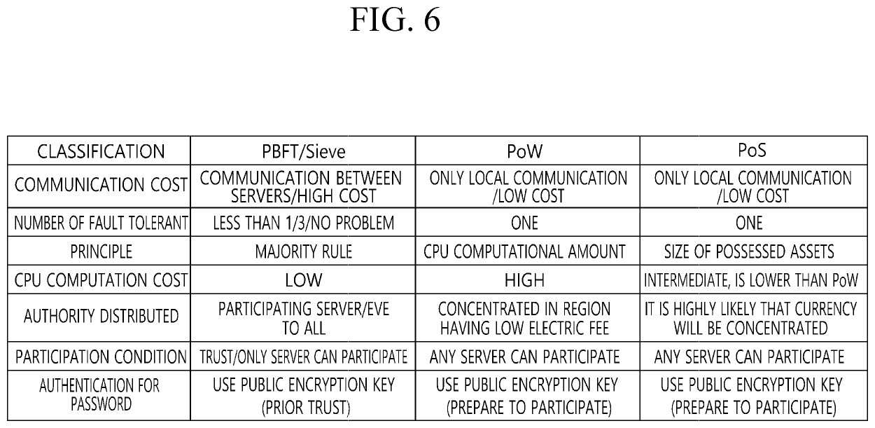

FIG. 6 illustrates comparison between consensus algorithms of a blockchain. Referring to FIG. 6, it is confirmed that the communication cost for the proof of trust is high, but the communication costs for the proof of work and the proof of stake are low. Further, it is confirmed that a CPU computation cost of the proof of trust is low, a CPU computation cost of the proof of work is high, and a CPU computation cost of the proof of stake is intermediate. In consideration thereof, in the exemplary embodiment of the present disclosure, when a consensus algorithm is selected based on a traffic amount of the sensing data, the consensus algorithm is selected according to the comparison of the traffic amount of the sensing data and a first threshold value and a second threshold value (first threshold value>second threshold value) set in advance. For example, when the traffic amount is equal to or higher than the first threshold value, the proof of stake is selected, when the traffic amount is equal to or higher than the second threshold value and is lower than the first threshold value, the proof of work is selected, and when the traffic amount is lower than the second threshold value, the proof of trust is selected.

The updating step includes a step of S22 of confirming a version of the firmware update by means of the smart contract recorded in the authenticated blockchain.

The updating step includes a step S23 of updating by executing the smart contract of the authenticated blockchain after changing a node consensus algorithm selected according to the change in the traffic amount of the sensing data to another node consensus algorithm.

The updating step includes a step S24 of charging and receiving a cost for the update through the virtual asset exchange device of the firmware update system.

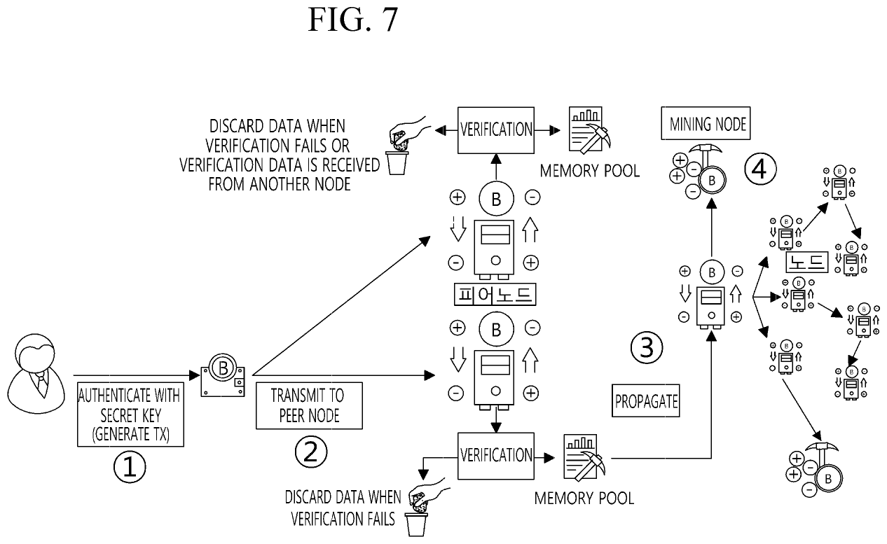

FIG. 7 is a view illustrating transaction propagation of a blockchain network to which a firmware update method according to another exemplary embodiment of the present disclosure is applied.

A node which receives the transaction data performs a verification process confirming whether a transmission address possesses a transmittable amount of virtual assets and then stores the transaction data in a transaction candidate group (Mempool) to be included in a newly generated block. When a mining node mines a new block, the mining node selects a transaction having a higher priority to propagate the completed block data to a blockchain network.

The automatic update is performed by the smart contract in a virtual machine by means of the transaction propagation to the blockchain network and cost related data is transmitted and received.

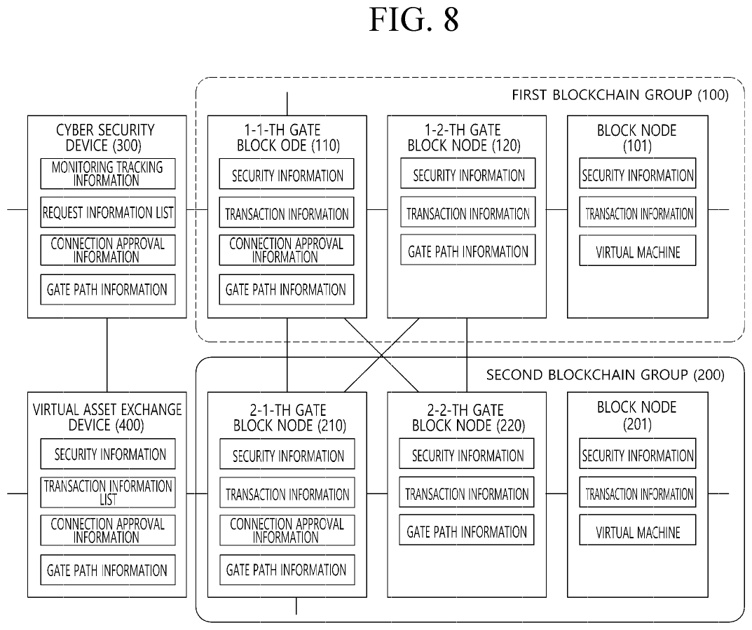

FIG. 8 is a view illustrating a blockchain group and a block node to which a firmware update system according to another exemplary embodiment of the present disclosure is applied.

A cyber security device 300 of a virtual asset tracking system is connected to a first blockchain group 100 and a virtual asset exchange device 400 of the virtual asset tracking system is connected to a second blockchain group 200.

The cyber security device 300 includes monitoring tracking information, a request information list, connection approval information, gate path information. The virtual asset exchange device 400 includes security information, a transaction information list, connection approval information, gate path information.

The first blockchain group 100 includes a 1-1-th gate block node 110, a 1-2-th gate block node 120, and a plurality of block nodes 101. The second blockchain group 200 includes a 2-1-th gate block node 210, a 2-2-th gate block node 220, and a plurality of block nodes 201. The 1-1-th gate block node 110 includes security information, transaction information, transaction approval information, and gate path information. The 1-2-th gate block node 120 includes security information, transaction information, and gate path information. The block node of the first blockchain group 100 includes security information, transaction information, and a virtual machine.

The second blockchain group 200 includes a 2-1-th gate block node 210, a 2-2-th gate block node 220, and a plurality of block nodes 201. The 2-1-th gate block node 210 includes security information, transaction information, transaction approval information, and gate path information. The 2-2-th gate block node 220 includes security information, transaction information, and gate path information. The block node of the second blockchain group 200 includes security information, transaction information, and a virtual machine.

The security information stored in the virtual asset exchange device, the 1-1-th gate block node, the 1-2-th gate block node, the 2-1-th gate block node, the 2-2-th gate block node, and the block node is information used for encryption/decryption, such as a hash value.

The transaction information which is distributed to be stored in the 1-1-th gate block node, the 1-2-th gate block node, the 2-1-th gate block node, the 2-2-th gate block node, and the block node corresponds to transaction data and includes contents regarding a source, a destination, and an amount.

The transaction information list stored in the virtual asset exchange device is metadata about transaction information which is distributed to be stored in the 1-1-th gate block node, the 1-2-th gate block node, the 2-1-th gate block node, the 2-2-th gate block node, and the block node. The transaction information list allows knowing transaction information possessed by an arbitrary block node and provides a criterion for determining a consensus algorithm.

A virtual machine which is stored and installed in a block node of the first blockchain group and a block node of the second blockchain group is an execution environment which operates as software which executes a source code.

Connection approval information stored in the cyber security device and the 1-1-th gate block node is information regarding a series of procedures required to connect the first blockchain group.

The connection approval information stored in the cyber security device and the 2-1-th gate block node is information regarding a series of procedures required to connect the first blockchain group.

The gate path information stored in the cyber security device, the 1-1-th gate block node, the 1-2-th gate block node, and the virtual asset exchange device is information about a path formed between the cyber security device and the virtual asset exchange device, and a path formed between the first block chain group and the second block chain group.

The 1-1-th gate block node and the 1-2-th gate block node belonging to the first block chain group may form a blockchain gate connection path in the 2-1-th gate block node and the 2-2-th gate block node belonging to the second block chain group.

The blockchain gate connection path may be connected in one of connection mode of a single line direct connection mode, a multiple line direct connection mode, a single line diagonal connection mode, and a multiple line diagonal connection mode.

The single line direct connection mode relates to a path which connects the 1-1-th gate block node and the 2-1-th gate block node or connects the 1-2-th gate block node and the 2-2-th gate block node.

The multiple line direct connection mode relates to a path which simultaneously connects the 1-1-th gate block node and the 2-1-th gate block node and connects the 1-2-th gate block node and the 2-2-th gate block node. The single line diagonal connection mode relates to a path which connects the 1-1-th gate block node and the 2-2-th gate block node or connects the 1-2-th gate block node and the 2-1-th gate block node.

The multiple line diagonal connection mode relates to a path which simultaneously connects the 1-1-th gate block node and the 2-2-th gate block node and connects the 1-2-th gate block node and the 2-1-th gate block node.

The gate connection path may include a flat regarding a connection mode of a single line direct connection mode, a multiple line direct connection mode, a single line diagonal connection mode, or a multiple line diagonal connection mode.

Even though components included in the firmware update system are separately illustrated in FIG. 2, the plurality of components is coupled to each other to be implemented by at least one module. The components are connected to a communication path which connects a software module or a hardware module in the apparatus to organically operate between the components. The components communicate with each other using one or more communication buses or signal lines.

The firmware update system may be implemented in a logic circuit by hardware, firm ware, software, or a combination thereof or may be implemented using a general purpose or special purpose computer. The device may be implemented using hardwired device, field programmable gate array (FPGA) or application specific integrated circuit (ASIC). Further, the device may be implemented by a system on chip (SoC) including one or more processors and a controller.

The firmware update system may be mounted in a computing device or a server provided with a hardware element as a software, a hardware, or a combination thereof. The computing device or server may refer to various devices including all or some of a communication device for communicating with various devices and wired/wireless communication networks such as a communication modem, a memory which stores data for executing programs, and a microprocessor which executes programs to perform operations and commands.

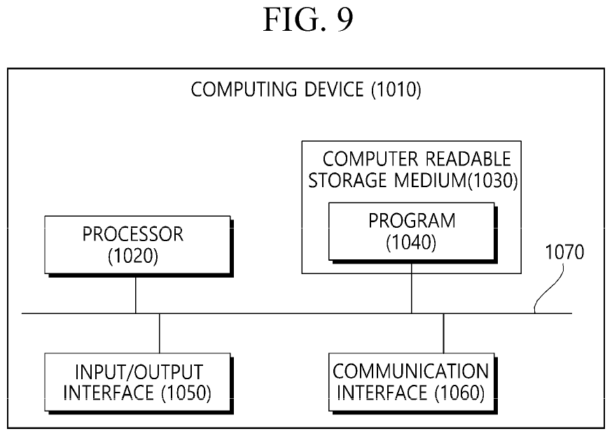

FIG. 9 is a block diagram illustrating a computing device which carries out exemplary embodiments of the present disclosure.

The computing device 1010 includes at least one processor 1020, a computer readable storage medium 1030, and a communication bus 1070.

The processor 1020 controls the computing device 1010 to operate. For example, the processor 1020 may execute one or more programs stored in the computer readable storage medium 1030. One or more programs may include one or more computer executable instructions and the computer executable instruction may be configured to allow the computing device 1010 to perform the operations according to the exemplary embodiments when it is executed by the processor 1020.

The computer readable storage medium 1030 is configured to store a computer executable instruction or program code, program data and/or other appropriate format of information. The program 1030 stored in the computer readable storage medium 1040 includes a set of instructions executable by the processor 1020. In one exemplary embodiment, the computer readable storage medium 1030 may be a memory (a volatile memory such as a random access memory, a non-volatile memory, or an appropriate combination thereof), one or more magnetic disk storage devices, optical disk storage devices, flash memory devices, and another format of storage mediums which is accessed by the computing device 1010 and stores desired information, or an appropriate combination thereof.

The communication bus 1070 includes a processor 1020 and a computer readable storage medium 1040 to interconnect various components of the computing device 1010 to each other.

The computing device 1010 may include one or more input/output interfaces 1050 and one or more communication interfaces 1060 which provide an interface for one or more input/output devices. The input/output interface 1050 and the communication interface 1060 are connected to the communication bus 1070. The input/output device (not illustrated) may be connected to the other components of the computing device 1010 by means of the input/output interface 1050.

In FIGS. 3 and 4, the respective processes are sequentially performed, but this is merely illustrative and those skilled in the art may apply various modifications and changes by changing the order illustrated in FIGS. 3 and 4 or performing one or more processes in parallel or adding another process without departing from the essential gist of the exemplary embodiment of the present disclosure.

The operation according to the exemplary embodiment of the present disclosure may be implemented as a program instruction which may be executed by various computers to be recorded in a computer readable medium. The computer readable medium indicates an arbitrary medium which participates to provide a command to a processor for execution. The computer readable medium may include solely a program command, a data file, and a data structure or a combination thereof. For example, the computer readable medium may include a magnetic medium, an optical recording medium, and a memory. The computer program may be distributed on a networked computer system so that the computer readable code may be stored and executed in a distributed manner. Functional programs, codes, and code segments for implementing the present embodiment may be easily inferred by programmers in the art to which this embodiment belongs.

The present embodiments are provided to explain the technical spirit of the present embodiment and the scope of the technical spirit of the present embodiment is not limited by these embodiments. The protection scope of the present embodiments should be interpreted based on the following appended claims and it should be appreciated that all technical spirits included within a range equivalent thereto are included in the protection scope of the present embodiments.

### Statement Regarding Prior Disclosures by the Inventor or a Joint Inventor

The inventors of the present application have made related disclosure in JANG DAEIL et. al., “A study on the development direction of response technology in response to the increase in virtual asset cybercrime abuse,” The Proceedings of the 2022 KIIT Summer Conference, Vol. 17, No. 1, ISSN 2005-7334, Jun. 3, 2022. The related disclosure was made less than one year before the effective filing date (Aug. 1, 2022) of the present application and the inventors of the present application are the same as those of the related disclosure. Accordingly, the related disclosure is disqualified as prior art under 35 USC 102(a)(1) against the present application. See 35 USC 102(b)(1) (A).

What is claimed is:

1. A blockchain based firmware update method by a blockchain based firmware update system, comprising:
building an authenticated blockchain by storing information about heterogeneous IoT firmware in a distributed block node; and
updating the heterogeneous IoT firmware based on a block node which forms the authenticated blockchain.

2. The blockchain based firmware update method according to claim 1, wherein in the building of an authenticated blockchain, metadata of the firmware is stored in the distributed block node and the firmware file is stored in a distributed file storage system.

3. The blockchain based firmware update method according to claim 2, wherein the metadata of the firmware includes a vender name, an IoT device type, a version of the firmware, a URL (uniform resource indicator) for downloading the firmware, a checksum, and a hash value of the firmware.

4. The blockchain based firmware update method according to claim 1, wherein the updating includes:
selecting an appropriate node consensus algorithm based on a traffic amount of sensing data collected from the heterogeneous IoT firmware.

5. The blockchain based firmware update method according to claim 4, wherein in the selecting of a node consensus algorithm, the selection is performed by the comparison between the traffic amount and a first threshold value and a second threshold value (first threshold value>second threshold value) which are set in advance, when the traffic amount is equal to or higher than the first threshold value, proof of stake is selected, when the traffic amount is equal to or higher than the second threshold value and lower than the first threshold value, proof of work is selected, and when the traffic amount is lower than the second threshold value, proof of trust is selected.

6. The blockchain based firmware update method according to claim 4, wherein the updating includes:
confirming a version of the firmware update by means of a smart contract recorded in the authenticated blockchain.

7. The blockchain based firmware update method according to claim 6, wherein the updating includes:
updating by executing the smart contract of the authenticated blockchain after changing the selected node consensus algorithm to another node consensus algorithm according to the change in the traffic amount of the sensing data.

8. The blockchain based firmware update method according to claim 7, wherein in the updating, the cost for the update is processed by a virtual asset exchange device of the firmware update system.

9. The blockchain based firmware update method according to claim 1, wherein a cyber security device of the firmware update system is connected to a first block chain group and a virtual asset exchange device of the firmware update system is connected to a second blockchain group and a 1-1-th gate block node and a 1-2-th gate block node belonging to the first block chain group form a blockchain gate connection path in a 2-1-th gate block node and a 2-2-th gate block node belonging to the second block chain group.

10. The blockchain based firmware update method according to claim 9, wherein the blockchain gate connection path is connected in one of connection mode of a single line direct connection mode, a multiple line direct connection mode, a single line diagonal connection mode, and a multiple line diagonal connection mode.

11. A blockchain based firmware update system including a cyber security device and a virtual asset exchange device,
wherein the cyber security device and the virtual asset exchange device build an authenticated blockchain by storing information about a heterogeneous IoT firmware in a distributed block node, and the cyber security device updates the heterogeneous IoT firmware based on a block node which forms the authenticated blockchain.

12. The blockchain based firmware update system according to claim 11, wherein the cyber security device stores metadata of the firmware in the distributed block node and stores a firmware file in a distributed file storage system.

13. The blockchain based firmware update system according to claim 12, wherein the metadata of the firmware includes a vender name, an IoT device type, a version of the firmware, a URL (uniform resource indicator) for downloading the firmware, a checksum, and a hash value of the firmware.

14. The blockchain based firmware update system according to claim 11, wherein the cyber security device selects an appropriate node consensus algorithm based on a traffic amount of sensing data collected from the heterogeneous IoT firmware.

15. The blockchain based firmware update system according to claim 14, wherein the cyber security device selects the node consensus algorithm by the comparison between the traffic amount and a first threshold value and a second threshold value (first threshold value>second threshold value) which are set in advance, when the traffic amount is equal to or higher than the first threshold value, selects proof of stake, when the traffic amount is equal to or higher than the second threshold value and lower than the first threshold value, selects proof of work, and when the traffic amount is lower than the second threshold value, selects proof of trust.

16. The blockchain based firmware update system according to claim 14, wherein the cyber security device identifies a version of the firmware update by means of a smart contract recorded in the authenticated blockchain.

17. The blockchain based firmware update system according to claim 16, wherein the cyber security device updates by executing the smart contract of the authenticated blockchain after changing the selected node consensus algorithm to another node consensus algorithm according to the change in the traffic amount of the sensing data.

18. The blockchain based firmware update system according to claim 17, wherein the virtual asset exchange device processes the cost for the update.

19. The blockchain based firmware update system according to claim 11, wherein the cyber security device is connected to a first blockchain group and the virtual asset exchange device is connected to a second blockchain group, and a 1-1-th gate block node and a 1-2-th gate block node belonging to the first block chain group form a blockchain gate connection path in a 2-1-th gate block node and a 2-2-th gate block node belonging to the second block chain group.

20. The blockchain based firmware update system according to claim 19, wherein the blockchain gate connection path is connected in one of connection mode of a single line direct connection mode, a multiple line direct connection mode, a single line diagonal connection mode, and a multiple line diagonal connection mode.
